(19) United States
(12) Patent Application Publication
(10) Pub. No.: US 2022/0019411 A1
(43) Pub. Date: Jan. 20, 2022

(54) SYSTEMS AND METHODS FOR DEVICE-SPECIFIC CODE COMPLETION

(71) Applicant: Analog Devices, Inc., Wilmington, MA (US)

(72) Inventors: Jason Cockrell, Kernersville, NC (US); Jeremiah E. Simonsen, Kernersville, NC (US)

(73) Assignee: Analog Devices, Inc., Wilmington, MA (US)

(21) Appl. No.: 17/169,332

(22) Filed: Feb. 5, 2021

Related U.S. Application Data
(60) Provisional application No. 63/052,918, filed on Jul. 16, 2020.

(51) Int. Cl. G06F 8/33; G06F 9/445; G06F 11/36

(52) U.S. Cl. CPC G06F 8/33; G06F 11/3624; G06F 9/445

(57) ABSTRACT

Described herein are techniques for providing device-specific code completion. Some embodiments provide an integrated development environment (IDE) system that automatically determines an identity of a device and provides device-specific code completion suggestions. The IDE system loads a device module associated with the identity of the device. The device module stores information indicating classes, methods, and/or properties provided by a software driver of the device. The IDE system uses the information from the device module to determine device-specific code completion suggestions to provide to a user. For example, the user may be entering software code into a text editor of the IDE system. The IDE system may provide device-specific code completion suggestions to the user in the text editor.

### CROSS-REFERENCE TO RELATED APPLICATIONS

This application claims the benefit under 35 U.S.C. § 119(e) of U.S. Provisional Patent Application Ser. No. 63/052,918, entitled “DEVICE-SPECIFIC CONTEXT-SENSITIVE CODE COMPLETION ENABLED VIA REAL-TIME DEVICE DETECTION OVER A COMMON TCP/IP CLIENT AND DYNAMIC LOADING OF DEVICE DRIVER CLIENT MODULES,” filed on Jul. 16, 2020 under Attorney Docket No. G0766.70323US00, which is incorporated by reference herein in its entirety.

### FIELD OF THE DISCLOSURE

The present application relates to an integrated development environment (IDE) system that provides software code completion. In particular, described herein are systems and methods for providing device-specific code completion.

### BACKGROUND

Integrated development environments (IDEs) for software development sometimes provide the feature of code completion. The code completion is sometimes context sensitive, when static relationships between entities are known ahead of time and part of the IDE. An IDE may provide code completion suggestions to a user as the user is entering software code into an IDE. For example, a user writing PYTHON code for a software application may be provided PYTHON code completion recommendations.

### SUMMARY

Described herein are techniques for providing device-specific code completion. Some embodiments provide an integrated development environment (IDE) system that automatically determines an identity of a device and provides device-specific code completion suggestions. The IDE system loads a device module associated with the identity of the device. The device module stores information indicating classes, methods, and/or properties provided by a software driver of the device. The IDE system uses the information from the device module to determine device-specific code completion suggestions to provide to a user. For example, the user may be entering software code into a text editor of the IDE system. The IDE system may provide device-specific code completion suggestions to the user in the text editor.

According to one aspect, a method of software code development is provided. The method comprises: using a processor to perform: determining a first identity of a first device connected to a computing device; based on identification of the first identity of the first device, loading a first device module of a plurality of device modules, the first device module associated with the first identity, and the first device module comprising information indicating software coding constructs for the first device; determining a code completion suggestion using the first device module associated with the first identity; and providing the code completion suggestion to a user of the computing device.

According to another aspect, a system for software code development is provided. The system comprises: a processor, a non-transitory computer-readable storage medium storing instructions that, when executed by the processor, causes the processor to perform a method comprising: determining a first identity of a first device connected to the system; based on identification of the first identity of the first device, loading a first device module of a plurality of device modules, the first device module associated with the first identity, and the first device module comprising information indicating software coding constructs for the first device; determining a code completion suggestion using the first device module associated with the first identity; and providing the code completion suggestion to a user of the computing device.

According to another aspect, a non-transitory computer-readable storage medium storing instructions is provided. The instructions, when executed by a processor, cause the processor to perform a method comprising: determining a first identity of a first device connected to a computing device; based on identification of the first identity of the first device, loading a first device module of a plurality of device modules, the first device module associated with the first identity, and the first device module comprising information indicating software coding constructs for the first device; determining a code completion suggestion using the first device module associated with the first identity; and providing the code completion suggestion to a user of the computing device.

### BRIEF DESCRIPTION OF DRAWINGS

Various aspects and embodiments of the application will be described with reference to the following figures. It should be appreciated that the figures are not necessarily drawn to scale. Items appearing in multiple figures are indicated by the same reference number in all the figures in which they appear.

FIG. 1 illustrates an example environment in which some embodiments of the technology described herein may be implemented.

FIG. 2 illustrates a layer stack that may be implemented in some embodiments of the technology described herein.

FIG. 3 illustrates a process of software development, according to some embodiments of the technology described herein may be implemented.

FIG. 4 illustrates a process of providing a code completion suggestion, according to some embodiments of the technology described herein.

FIG. 5 illustrates a process of providing an indication of one or more software coding constructions to a user, according to some embodiments of the technology described herein.

FIG. 6 illustrates a process of executing a set of software code on multiple different devices, according to some embodiments of the technology described herein.

FIG. 7 illustrates an example of executing a set of software on multiple different devices, according to some embodiments of the technology described herein.

FIG. 8 illustrates an example computer system, according to some embodiments of the technology described herein.

### DETAILED DESCRIPTION

A user may use an integrated development environment (IDE) to facilitate development of software. For example, an IDE may provide a text editor where a user may enter code. The IDE may provide the user with code completion suggestions as the user is entering code into the text editor. A user of an IDE may use the IDE to develop software for a transceiver device. For example, the user may use the IDE to develop software to control a device. Different devices may have different software drivers that provide software coding constructs for communicating with and/or operating a respective device. A “software coding construct” is a class, method, or property that may be used in software code. Continuing with the example above, the transceiver may have a software driver that provides a set of software coding constructs for communicating with and/or operating the transceiver.

Conventional IDE systems are developed to provide code-completion suggestions for one or more software languages. For example, the ECLIPSE IDE system supports C, C++, PYTHON, PERL, JAVA, RUBY, and other software programming languages. A conventional IDE system is developed to provide a central interface that has utility for various different needs of developers who are writing code using the software programming language(s) supported by the IDE system. For example, a first software developer may use an IDE system to develop a web application for a backend of a website, and a second software developer may use the same IDE system to develop control software for an unmanned aerial vehicle (UAV).

The inventors have recognized that users may use an IDE system to develop software for a specific device (e.g., a specific transceiver model). Due to the variety of developer needs that an IDE system may facilitate, there may be many possible devices for which the IDE system may be used to develop software. Given the number of possible devices, conventional IDE systems do not incorporate libraries of device-specific coding constructs, and thus are unable to provide device-specific code completion. Accordingly, conventional IDE systems are limited in their ability to facilitate development of software for a device. For example, if a user is developing software for a transceiver, a conventional IDE system would not have the capability to indicate software coding constructs provided by a software driver of the transceiver as code completion suggestions to a user. As conventional IDEs do not provide device-specific code completion suggestions, a user may have to learn coding constructs provided by a software driver of the device and/or manually look up the software coding constructs (e.g., in documentation of the device).

To address the above-described limitations of conventional IDE systems, the inventors have developed techniques for providing a device-centric IDE system. The techniques described herein provide an IDE system that provides device-specific code completion suggestions. The techniques allow an IDE system to facilitate software development for one or more devices by indicating device-specific software coding constructs (e.g., provided by a software driver of each of the device(s)) as code completion suggestions to a user writing software code. The IDE system determines an identity of a device (e.g., that the user is writing software code for). Based on identification of the device, the system loads a device module associated with the identity of the device. The device module includes information indicating software coding constructs for communicating with and/or operating the device. The IDE system uses the device module to determine a code completion suggestion and provides the code completion suggestion to the user (e.g., as the user writes software code for the device).

Further aspects of the present application provide an integrated development environment (IDE) for software development that includes context-sensitive code completion, even absent context-sensitive client relationships being known in advance as part of the IDE. In some embodiments, real-time device detection and dynamic loading of client modules is employed to allow for presenting the developer with device-specific code completion options, rather than relying on conventional, statically defined classes, methods, and properties being part of the IDE itself. The IDE may be generally blind to device-specific information.

According to aspects of the present application, an IDE of the types described may be employed to allow a developer to install any or all of several different device-specific client modules, and to use a single IDE to author applications which connect to a device via a single eval client, but which target only the connected device. In some embodiments, the developer can plug in an ethernet cable, for instance, to connect to one device, engage in development work for some time on an application targeting that device's driver, then later, switch cables, connect to a different device, and proceed to develop targeting that device's driver instead. This transition from one device to another requires no active, user-controlled context-switching within the IDE, and appears entirely seamless to a person watching the screen.

In at least some embodiments, a further benefit is conferred if new devices are added over time, or if versioned updates to the device modules are published. In some embodiments, neither the IDE nor the eval client contains any static references to any of the device modules, so there is no need to install updates to these layers of the stack if the device modules are updated. Moreover, device modules for devices can be added to increase the number of devices for which the IDE system can provide device-specific code completion suggestions for. Developers using the IDE can download updated client modules directly to their working directory and will find that the next time they connect to their devices, the IDE will then have the latest available suggestions for code completion, without the IDE itself receiving any updates.

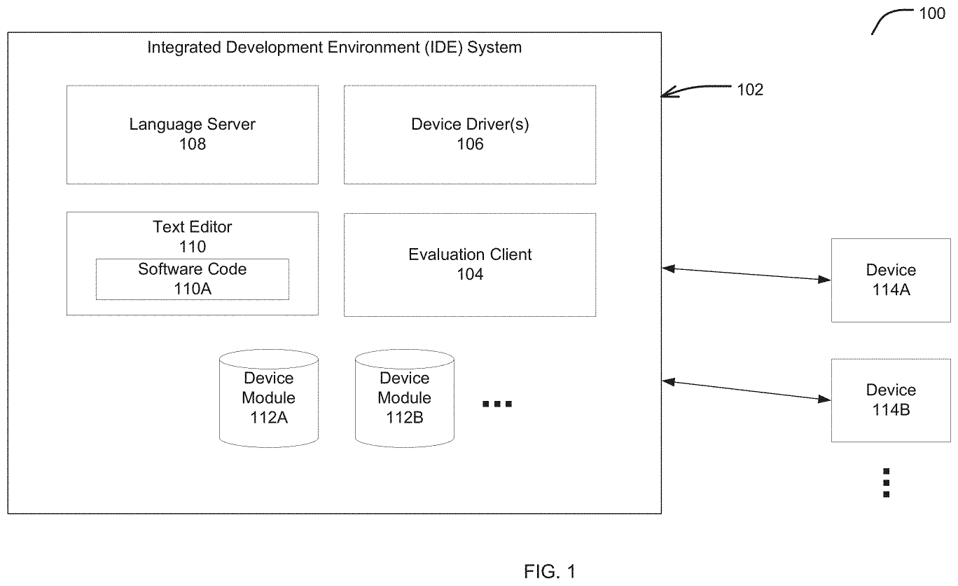

FIG. 1 illustrates an example of an environment 100 in which some embodiments of the technology described herein may be implemented. As shown in FIG. 1, the environment 100 includes an integrated development environment (IDE) system 102 in communication with a plurality of devices 114A-114B.

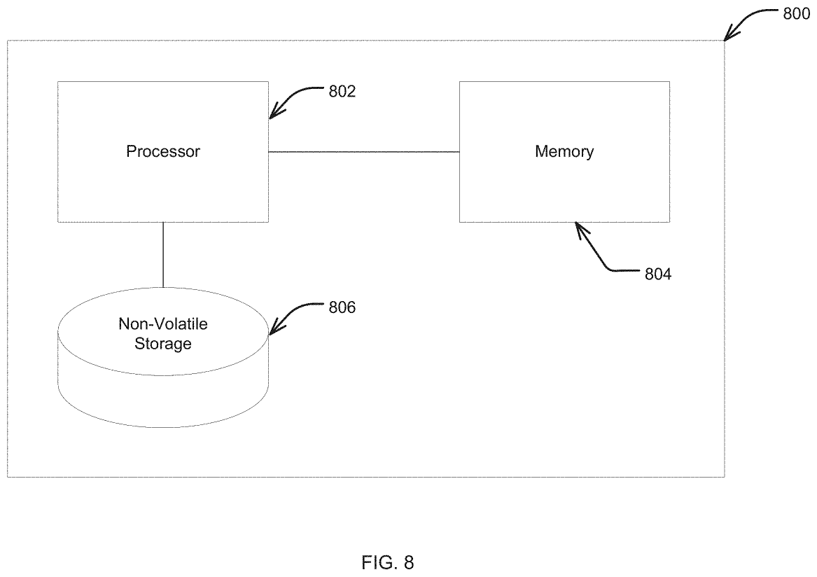

In some embodiments, the IDE system 102 may be implemented on a computer system. For example, the IDE system 102 may be implemented on computer system 800 described herein with reference to FIG. 8. In some embodiments, one or more components of the IDE system 102 may be implemented as software modules of the IDE system 102. As shown in the example embodiment of FIG. 1, the IDE system 102 includes an evaluation client 104, one or more device drivers 106, a language server 108, a text editor 110, and a plurality of device modules 112A-112B.

In some embodiments, the evaluation client 104 may be configured to establish a connection with a device. For example, the evaluation client 104 may establish a connection with one or more of devices 114A-114B that can be connected to the IDE system 102 as shown in FIG. 1A. In some embodiments, the evaluation client 104 may be configured to establish a connection over a physical port with the device(s). For example, the evaluation client 104 may establish a connection over a USB port, an ethernet port, a VGA port, or any other type of physical connection with the device. In some embodiments, the evaluation client 104 may be configured to establish a wireless connection with the device. For example, the evaluation client 104 may establish a Bluetooth® connection, an infrared connection, or other type of wireless connection with the device. In some embodiments, the evaluation client 104 may be configured to establish a virtual port connection through which the IDE system 102 can communicate with the device. For example, the evaluation client 104 may establish a transmission control protocol/Internet Protocol (TCP/IP) port connection with the device(s).

In some embodiments, the evaluation client 104 may be configured to manage communication between the IDE system 102 and a connected device (e.g., devices 114A-B). In some embodiments, the evaluation client 104 may be configured to transmit messages to the device. For example, the evaluation client 104 may pass function calls (e.g., invoked by the language server 108) to the device. In some embodiments, the evaluation client 104 may be configured to receive messages from the device. For example, the evaluation client 104 may receive a message generated by the device in response to a function call transmitted to the device. In another example, the evaluation client 104 may receive status messages from the device.

In some embodiments, the device driver(s) 106 may include software that allows the IDE system 102 to communicate with and/or operate one or more devices (e.g., devices 114A-114B) connected to the device (e.g., via the evaluation client 104). The device driver(s) 106 may provide software coding constructs for use in software code for communication with and/or operation of the device. In some embodiments, the device driver(s) 106 may include one or more files that allow an operating system of the IDE system 102 to communicate with and/or operate the device(s). The device driver(s) 106 may be used to transmit and/or receive messages to and from the device(s). In some embodiments, the device driver(s) 106 may be used by a software application of the IDE system 102 to communicate with the device(s). The software application of the IDE system 102 may be configured to use the driver(s) 106 to operate the device(s). For example, the software application may communicate with an operating system (OS) of a computer system to invoke functionality of the device(s). The operating system may invoke functionality of a device using a device driver. In some embodiments, the device driver(s) 106 may be used by the evaluation client 104 to communicate with the device(s).

As an illustrative example, the device driver(s) 106 may include a driver for a transceiver device. The IDE system 102 may be configured use the driver to communicate with the transceiver device. For example, the IDE system 102 may use the driver to invoke a function of the transceiver device that causes the transceiver device to transmit information at an indicated frequency. In another example, the IDE system 102 may use the driver to transmit data to the transceiver device that is to be stored in memory of the transceiver device. In yet another example, the IDE system 102 may use the driver to transmit a command to the transceiver device to cause the transceiver device to enter a low power mode.

In some embodiments, the language server 108 may be configured to facilitate development of software code. In some embodiments, the language server 108 may be configured to determine an identity of a device connected to the IDE system 102. The language server 108 may be configured to use the determined identity of the device to provide device-specific code completion suggestions. For example, the language server 108 may provide indications of one or more software coding constructs that may be used to communicate with and/or operate the device to a user writing software code. In some embodiments, the software coding construct(s) may be provided by a device driver associated with the device.

In some embodiments, the language server 108 may be configured to determine an identity of a device connected to the IDE system 102 (e.g., device 14A and/or device 114B). In some embodiments, the language server 108 may be configured to determine the identity of the device by transmitting an instruction to the device (e.g., via the evaluation client 104) that, when executed by the device, causes the device to provide an indication of the device's entity to the IDE system 102. For example, the language server 108 may use the evaluation client 104 to transmit an instruction to execute the method “identify( )” to the device that causes the device to transmit, to the EIS system 102, an indication of the identity of the device. For example, the device may transmit a model number, a software driver version, and/or other information indicating the identity of the device. In the example of a transceiver device, the transceiver device may transmit a model number and software version number in response to executing an “identify( )” function.

In some embodiments, the language server 108 may be configured to use the determined identity to load a device module associated with the identity of the device. For example, the language server 108 may be configured to determine that device 114A is connected to the IDE system 102 (e.g., through a USB connection). The IDE system 102 may load the device module 112A when the IDE system 102 determines that device 114A is connected to the IDE system 102. The language server 108 may use the device module 112A to determine a completion suggestion. In some embodiments, the language server 108 may be configured to analyze code entered by a user (e.g., user code 110A entered in text editor 110) and determine the code completion suggestion based on the analysis. For example, the language server 108 may: (1) determine a context of the code; (2) determine the code completion suggestion from the context; and (3) provide the code completion suggestion to a user of the IDE system 102.

In some embodiments, the language server 108 may be configured to determine a device-specific code completion suggestion. For example, the language server 108 may determine a code completion suggestion to be an indication of a software coding construct provided by a driver of a device. In some embodiments, the language server 108 may be configured to determine the code completion suggestion using a loaded device module (e.g., module 112A or module 112B) associated with the device. The module associated with the device may include information indicating software coding constructs (e.g., methods, classes, and/or properties) for operating the device. The language server 108 may be configured to identify one or more of the software coding constructs and provide an indication of the identified coding construct(s) as the code completion suggestion. As an illustrative example, IDE system 102 may determine that the IDE system 102 is connected to an ADRV9002 transceiver developed by Analog Devices Inc. The language server 108 may identify a string of “adrv.9002.” in the software code. In this example, the language server 108 may provide an indication of functions available for the transceiver that can be entered after the “adrv.9002.” string identified in the software code. For example, the language server 108 may provide a list of possible methods and/or classes provided by the software driver of the ADRV9002 in a graphical user interface (GUI) which the user can select to insert after the “adrv.9002.”.

As shown in the example embodiment of FIG. 1, the IDE system 102 includes a text editor 110. Software code 110A may be entered into the text editor 110. For example, a user developing software code for the device 114A may enter software code for operating the device 114A into the text editor 110. In some embodiments, the text editor 110 may provide a graphical user interface (GUI) for displaying code completion suggestions to a user (e.g., provided by language server 108). For example, the text editor 110 may indicate a list of one or more software coding constructs (e.g., methods, classes, and/or properties) that a user may use in the software code. In some embodiments, the GUI may be configured to allow the user to select from the software coding construct(s). The GUI may be configured to input the selected software coding construct into the software code 110A in response to the user selection. For example, the GUI may enter a method selected by the user at a cursor in the text editor 110.

In some embodiments, the text editor 110 may be a command line interface. For example, the command line interface may be provided as part of a debugging application for debugging operation of a connected device (e.g., device 114A and/or device 114B). The IDE system 102 may be configured to provide code completion suggestions (e.g., determined by language server 108) in the command line interface. The command line interface may allow the user to input software code from the code completion suggestion into one or more command lines. For example, the command line interface may allow the user to toggle among one or more software coding constructs that can be entered into the command line (e.g., by pressing the left and/or right arrow keys).

As shown in the example embodiment of FIG. 1, the IDE system 102 includes multiple device modules including device module 112A and device module 112B. As indicated by the dotted lines after device module 112B, the IDE system 102 may include any number of device modules. Each device module may include information indicating software coding constructs for a device associated with the device module. For example, the device module 112A may be associated with device 114A and device module 112B may be associated with device 114B. The device module 112A may store information indicating software coding constructs for device 114A (e.g., to operate and/or communicate with the device 114A) and device module 112B may store information indicating software coding constructs for device 114B (e.g., to operate and/or communicate with the device 114B). For example, the device module 112A may store information indicating methods, classes, and/or properties provided by a software driver of device 114A and device module 112B may store information indicating methods, classes, and/or properties provided by a software driver of device 114B. In some embodiments, the IDE system 102 may be configured to load a device module when the IDE system 102 determines an identity of a device connected to the IDE system 102. The loaded device module may provide software coding constructs that may be provided as code completion suggestions by language server 108 to the user.

In some embodiments, a device module may be a file indicating software coding constructs provided by a software driver of a device that the device module is associated with. For example, the device module may be a DLL file. In some embodiments, the device module is selected by the evaluation client 104 to be loaded (e.g., for use by the language server 108 to determine code completion suggestions). In some embodiments, the device module may be imported into various software programming languages. For example, the device module may be imported into PYTHON, C #, or any other programming language. In some embodiments, device modules may be obtained from an external system. For example, the IDE system 102 may obtain a device module from an Internet website (e.g., provided by a manufacturer of a device).

As shown in the example embodiment of FIG. 1, the IDE system 102 may be configured to connect to multiple different devices include device 114A and device 114B. As indicated by the dotted lines, the IDE system 102 may be configured to connect to any number of devices. In some embodiments, the IDE system 102 may be configured to connect to a device with a wired connection (e.g., USB, VGA, or other type of wired connection). In some embodiments, the IDE system 102 may be configured to connect to a device with a wireless connection (e.g., Bluetooth®, infrared, or other type of wireless connection). In some embodiments, the IDE system 102 may be configured to communicate with a connected device. For example, the IDE system 102 may transmit and receive messages from the connected device. The IDE system 102 may be configured to transmit instructions to the device. The instructions may cause the device to execute one or more functions. The IDE system 102 may be configured to obtain information from the device (e.g., in response to execution of an instruction). In some embodiments, software code executed by the IDE system 102 may operate the device (e.g., using a device driver associated with the device).

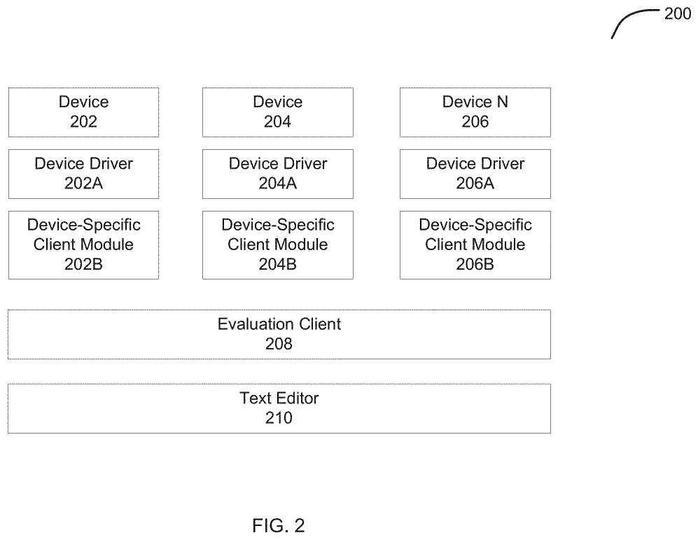

FIG. 2 illustrates a software layer stack 200, according to some embodiments of the technology described herein. The software layer stack 200 may be implemented by a computing device. For example, the software layer stack 200 may be implemented by IDE system 102 described herein with reference to FIG. 1. According to an aspect of the present application, an IDE (e.g., IDE system 102) employing multiple layers of software is provided to allow for context-sensitive device-specific code completion. The multiple layers of software may span substantially from the devices 202, 204, and 206 to the developer using a text editor 210.

As shown in FIG. 2, the multiple layers of software comprise:
1.) Device drivers 202A, 204A, and 206C. Each of the drivers may be configured to interface with firmware to operate and configure a respective device. In some embodiments, this layer is device-specific, meaning that for a given device (e.g., a given transceiver), there is a given device driver. This layer may be written in C or any other suitable language, and may compile to a server application running on a Linux microprocessor, as a non-limiting example. In some embodiments, an operating system of a computing device may use the device drivers 202A, 204A, 206A to communicate with and/or operate the respective devices 202, 204, and 206. In some embodiments, software applications of the computing device may invoke a driver using the operating system. In some embodiments, the software applications may directly invoke a driver without using the operating system.
2.) Evaluation client (also referred to as “eval client”) 208. The evaluation client 208 may be configured to establish a connection (e.g., a TCP/IP connection or other connection) with devices 202, 204, and 206. For example, the evaluation client 208 may establish a connection over an ethernet cable. The evaluation client 208 may be configured to manage the passing of messages to and from the device driver, for instance, via remote procedure call. This layer may be common across devices. Thus, a system that invokes the evaluation client need not be aware at programming time of which specific device is connected. This layer may be written in PYTHON, C #, .NET, or any other suitable programming language. In some embodiments, the evaluation client 108 may use Castle Windsor to dynamically load dependencies. In some embodiments, an existing .NET library may be used to establish a TCP/IP connection, such as System.Net.FtpClient. While TCP/IP connections represent one example of a suitable connection type, other connections type may be implemented in addition to or as an alternative of a TCP/IP connection. For example, other serial port connections may be implemented.
3.) Device modules 202B, 204B, and 206B. Each device module is associated with a respective device. In some embodiments, these modules are detected and loaded dynamically by the evaluation client 208 after the evaluation client establishes a connection (e.g., a TCP/IP connection or other connection, such as a different type of serial connection) to a device. The device modules store indications of software coding constructs (e.g., classes, methods, and properties) associated with the device drivers for their respective individual devices. The device modules may allow applications running on a personal computer to target and invoke the device driver over the TCP/IP connection. In some embodiments, the device modules may be written in C #, .NET, or any other suitable programming language. In some embodiments, a device module may be automatically generated from templates designed to mirror the software coding constructs (e.g., classes, methods, and properties) available in the device driver. For example, the device module may be a DLL file that mirrors software coding constructs, and which may be loaded by an IDE system.
4.) Text editor 210. In some embodiments, an IronPython editor may be employed. In some embodiments, the text editor 210 may be implemented by adding operational logic over an existing text editor, for instance, a Scintilla editor. This text editor supplies the developer with context-sensitive code completion suggestions (e.g., determined by language server 108). For example, the IDE system may be configured to statically reflect on software coding constructs, and recursively traverse the software coding constructs (e.g., classes, methods, and/or properties) available in known assemblies (e.g., in a loaded device module). The text editor 210 may further extend code completion by tracking the types of variable assignments within the code. For example, the text editor 210 may traverse the developer's code linearly or recursively, or by scanning for assignment calls, or otherwise. The text editor 210 may be written in C #, .NET, or any other suitable language, and may occur within a software application intended for transceiver evaluation, or intended for interfacing with device drivers more generally.

In some embodiments, the IDE system may be configured to include behind-the-scenes real-time execution of client method invocation via parsing of developer's code. In contrast to static code completion, use of this layer may provide enhanced functionality. The IDE system may include a built-in execution engine which, while the developer is authoring code, silently reads the code in progress, reflects upon the named software coding constructs (e.g., classes, properties, and/or methods), dynamically loads relevant device modules, and executes in real-time the software code (e.g., methods and variable assignments written in the code), or a select subset thereof. In some embodiments, when the computer system (e.g., a developer's personal computer) is able to connect to a device, for instance, via TCP/IP connection over an ethernet cable. The developer's code may include lines which would establish such a connection at run-time and return a pointer to a device object. The IDE system may make load the relevant device modules (e.g., in the IDE's current working directory, other directories, or available online). The IDE system may be configured to determine an identity of a device (e.g., detect the presence of the device), identify the relevant device modules, and dynamically load the device modules into the IDE. In some embodiments, the IDE system may be configured to reflect upon the device modules to examine software coding constructs (e.g., classes, methods, and properties) indicated by the client modules, and supply those entities along with the logical relationships between them to the text editor, so that the context-sensitive code completion may be populated with device-specific suggestions in a context-sensitive manner.

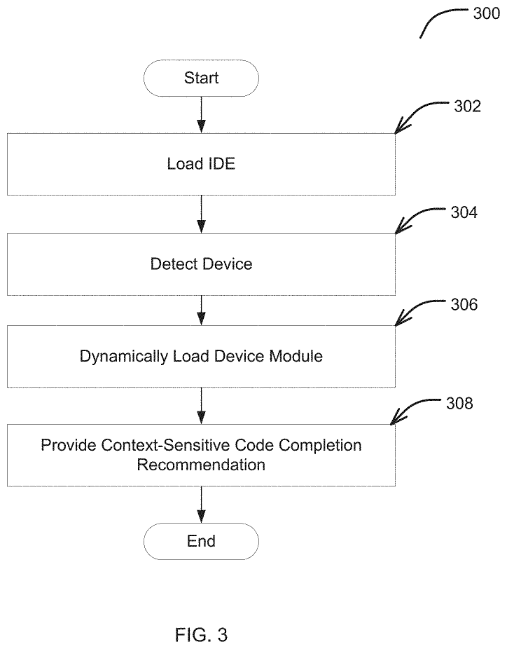

FIG. 3 illustrates a process 300 of software development, according to some embodiments of the technology described herein. Process 300 may be performed by any suitable computing device. For example, process 300 may be performed by IDE system 102 described herein with reference to FIG. 1.

Process 300 begins at block 302, where the system loads an IDE. For example, the system may load one or more components of IDE system 102. Next, process 300 proceeds to block 304, where the system detects a device. The system may be configured to determine an identity of the device. Next, process 300 proceeds to block 306, where the system dynamically loads a device module associated with the detected device. Next, process 300 proceeds to block 308, where the system provides a context-sensitive code completion recommendation. In this manner, context-sensitive code completion recommendations may be made without static relationships being pre-existing in the IDE. Example techniques for performing the act at each of blocks 302-308 are described herein.

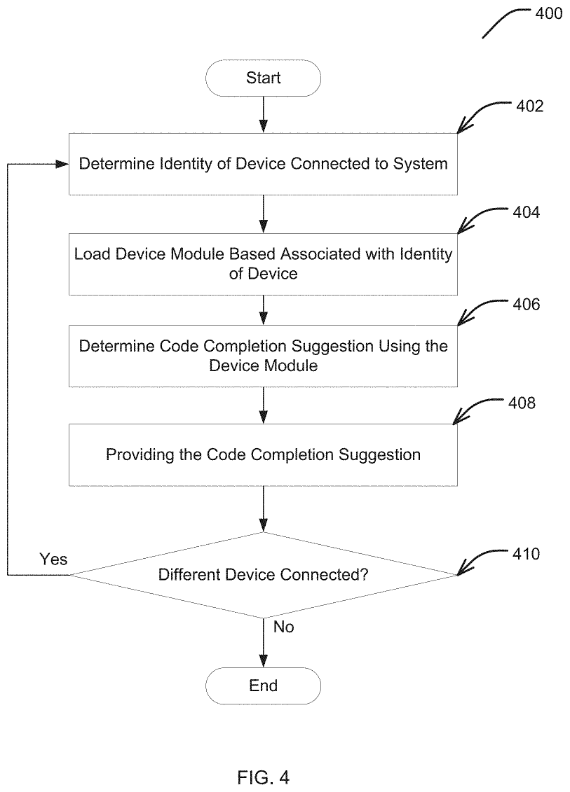

FIG. 4 illustrates a process 400 of providing a code completion suggestion, according to some embodiments of the technology described herein. Process 400 may be performed by any suitable computing device. For example, process 400 may be performed by IDE system 102 described herein with reference to FIG. 1.

Process 400 begins at block 402, where the system determines an identity of a device connected to the system. In some embodiments, the system may be configured to determine the identity of the device by: (1) transmitting an instruction to the device that, when executed by the device, causes the device to transmit an indication of the identity to the system; and (2) determining the identity of the device using the indication of the identity obtained from the device. For example, the system may transmit an “identify( )” instruction that, when executed by the device, causes the device to transmit an indication of the identity of the device. For example, the system may receive a model number and/or software version (e.g., software driver version) from the device.

As an illustrative example, the system may be connected to an ADRV9002 transceiver device manufactured by Analog Devices Inc. of Wilmington, Mass. In this example, the system may transmit an “identify( )” instruction to the transceiver. In response to transmitting the instruction, the system may receive, from the transceiver, the transceiver model number “ADRV9002” and a software driver version number. The system may determine the identity of the transceiver using the obtained information.

Next, process 400 proceeds to block 404, where the system loads a device module associated with the identity of the device. In some embodiments, the device module may include information indicating software coding constructs for the device (e.g., provided by a software driver of the device). For example, the device module may include information about methods, classes, and/or properties for use in operating and/or communicating with the device. In some instances, one or more of the software coding constructs indicated by the device module may be unique to the device. Continuing with the example of the transceiver, the system may load a device module associated with the ADRV9002 transceiver device. The device module may include information indicating software coding constructs for operating the transceiver device.

Next, process 400 proceeds to block 406, where the system determines a code completion suggestion using the device module. In some embodiments, the system may be configured to determine a set of candidate software coding constructs (e.g., indicated by the device module) that may be entered into the software code. In some embodiments, the system may be configured to analyze code to determine the code completion suggestion. The system may be configured to identify one or more software coding constructs to suggest to the user based on the analyzing. As an illustrative example, the use may enter (e.g., into a text editor) “adrv9002.”. The system may determine one or more methods, classes, and/or properties of the transceiver software driver that can be entered after “advr9002.”. For example, the system may determine one or more methods that are available for use by the advr9002 software object. In some embodiments, the system may be configured to select one or more software coding constructs from the device module that may be used.

In some embodiments, the system may be configured to analyze the software code by compiling and executing at least a portion of the software code. For example, the system may select a portion of software code entered by the user, compile the code, and execute the compiled code. The system may use the execution of the compiled code to determine one or more software coding constructs (e.g., provided by the software driver) that can be used in the code. For example, the system may identify one or more software coding constructs that would be valid if entered by the user.

Next, process 400 proceeds to block 408 where the system provides the code completion suggestion. In some embodiments, the system may be configured to provide the code completion suggestion in a GUI (e.g., of a text editor) in which software code is entered. For example, the system may provide the code completion suggestion by displaying a listing of software coding constructs that can be used in the software code. In some embodiments, the system may be configured to provide a list of the software coding constructs and allow selection of an item from the list. The system may be configured to enter a selected coding construct into the software code. In some embodiments, the system may be configured to allow toggling among a plurality of coding constructs that can be entered into the software code. For example, the system may provide the code completion suggestion in a command line interface (e.g., of a debugging application). The system may allow the user to toggle through multiple software coding constructs that can be entered into a command line.

Next, process 400 proceeds to block 410, where the system determines whether a different device is connected. For example, a first device connected to the system may be disconnected and a second device may be connected. The system may be configured to determine that a connection with the first device has been ended (e.g., as a result of disconnecting the first device). If the system determines that a different device has been connected at block 410, then process 400 proceeds to block 402 where the system determines an identity of the second device connected to the system. The system then proceeds to perform the acts at blocks 404-410 for the second device. If the system determines that a different device has not been connected at block 410, then process 400 ends. In some embodiments, the system may be configured to continue to determine code completion suggestions (e.g., specific to the connected device). For example, the system may continuously analyze software code to determine and provide code completion suggestions while the system is used.

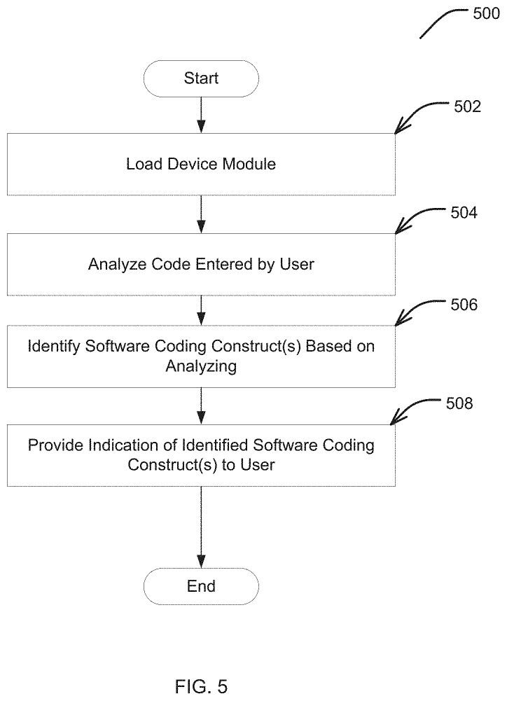

FIG. 5 illustrates a process 500 of providing an indication of one or more software coding constructions to a user, according to some embodiments of the technology described herein. For example, process 500 may be performed as part of process 400 described herein with reference to FIG. 4. Process 500 may be performed by any suitable computing device. For example, process 500 may be performed by IDE system 102 described herein with reference to FIG. 1.

Process 500 begins at block 502 where the system loads a device module (e.g., after identifying a device as described at block 402 of process 400). In some embodiments, the system may be configured to load the device module by loading a file (e.g., a DLL tile). For example, the system may load a DLL file into a language server that determines code completion suggestions. The language server may use the DLL file to determine the code completion suggestions.

Next, process 500 proceeds to block 504, where the system analyzes code entered by the user. In some embodiments, the system may be configured to analyze the code by identifying software code related to the device (e.g., identified by the system). For example, the system may identify software code that uses software coding constructs indicated by the device module. In some embodiments, the system may be configured to analyze the code by identifying one or more software coding constructs specific to an identified device. For example, the system may identify methods, classes, and/or properties in the software code provided by a software driver of the device. The system may be configured to identify the software coding constructs using the loaded device module. As an illustrative example, the system may identify software objects that are specific to a transceiver device.

In some embodiments, the system may be configured to analyze the code by compiling at least a portion of the software code. For example, a language server of the system may compile code in the background. The language server may use results of executing the compiled code to determine valid software coding constructs that may be used in the software code. In some embodiments, the system may be configured to identify a software object specific to the device. For example, the system may identify a software object of a class that is specific to the device (e.g., a transceiver device).

Next, process 500 proceeds to block 506, where the system identifies one or more software coding constructs based on the analyzing. In some embodiments, the system may be configured to identify the software coding construct(s) from the loaded device module. For example, the system may identify one or more methods, classes, and/or properties that can be used in the software code. In some embodiments, the system may be configured to determine software coding construct(s) that are valid in a portion of the code. For example, the system may determine software coding construct(s) that would successfully compile if entered into a section of the software code (e.g., at a cursor location in a text editor). In some embodiments, the system may be configured to identify software coding construct(s) that are available for a software object in the software code. For example, the system may identify device-specific methods available for an object instantiated by the software code.

Next, process 500 proceeds to block 508, where the system provides an indication of the identified software coding construct(s) to the user. In some embodiments, the system may be configured to provide an indication of the software coding construct(s) in a GUI (e.g., of a text editor). In some embodiments, the system may be configured to provide a listing of the software coding construct(s). A user may select from the listing of software coding construct(s). In some embodiments, the system may be configured to allow a user to toggle through the software coding construct(s). In some embodiments, the system may allow a user to select from the listing of the software coding construct(s). The system may be configured to a selected software coding construct when selected by the user.

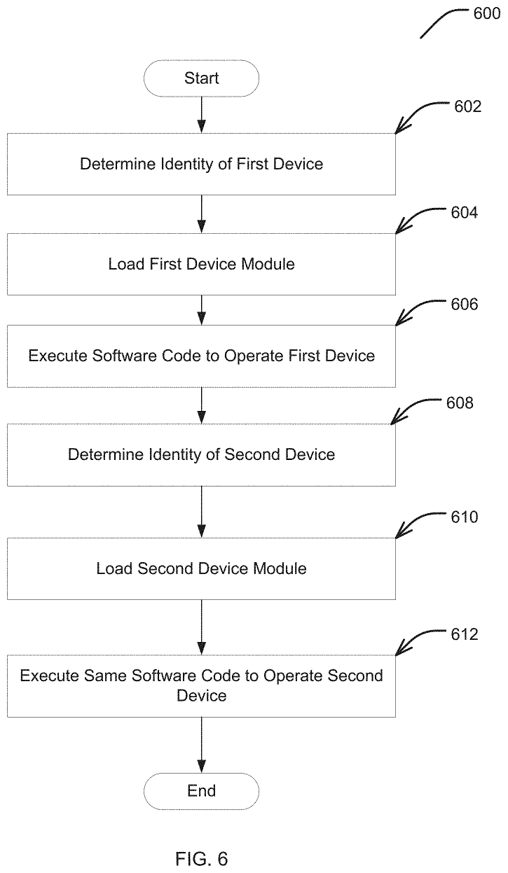

FIG. 6 illustrates a process 600 of executing a set of software code on multiple different devices, according to some embodiments of the technology described herein. Process 600 may be performed by any suitable computing device. For example, process 600 may be performed by IDE system 102 described herein with reference to FIG. 1.

Process 600 begins at block 602, where the system determines an identity of a first device connected to the system. For example, the system may determine the identity of the first device as described at block 402 of process 400 (e.g., by transmitting an instruction to the device to cause the device to provide an indication of its identity). Next, process 600 proceeds to block 604, where the system loads a device module associated with the identity of the first device (e.g., as described at block 404 of process 400).

Next, process 600 proceeds to block 606, where the system executes software code to operate the first device. For example, the system may execute software using an evaluation board connected to the first device. In some embodiments, the system may be configured to execute the software code by: (1) compiling the software code to obtain an executable file (e.g., a binary file); and (2) executing the executable file. As an illustrative example, the software code may include instructions for a software application that performs a test procedures on the device. For example, the first device may be a first transceiver device and the software application may test functionality of the first transceiver device (e.g., by causing the first transceiver device to transmit data over one or more frequencies).

Next, process 600 proceeds to block 608, where the system determines an identity of a second device. In some instances, the second device may be swapped for the first device. For example, a connection to the first device may be closed and a connection with the second device may be initiated (e.g., by disconnecting a wired connection from the first device and connecting it to the second device). In some embodiments, the system may be configured to determine the identity of the second device 608 when the system connects to the second device. For example, the system may determine the identity of the second device as described at block 402 of process 400.

In some embodiments, the system may be configured to detect that the first device is disconnected. The system may be configured to determine the identity of the second device in response to determining that the second device is connected. For example, an evaluation client of the system may establish a connection with the second device. The system may be configured to determine the identity of the second device when the evaluation client establishes the connection. In some embodiments, the first device may be “hot swapped” for the second device. The system may remain in operation while the first device is replaced with the second device. For example, a first transceiver device may be replaced with a second transceiver device. The second transceiver device may be a different model than the first transceiver device.

Next, process 600 proceeds to block 610, where the system loads a second device module associated with the second device. For example, the system may load the second device module as described at block 404 of process 400.

Next, process 600 proceeds to block 612, where the system executes the software code used for the first device. In some embodiments, the system may be configured to: (1) determine one or more software coding constructs specific to the second device using the second device module; and (2) use the software coding construct(s) in place of one or more software coding constructs specific to the first device. For example, the software code may be a software application to perform a testing procedure. The system may be configured to replace software constructs specific to the first device with software constructs specific to the second device. The system may then repeat the testing procedure for the second device. Thus, the system may allow the second device to be hot swapped for the first device without user modification of the software code. Accordingly, the system may allow one set of software code developed by a user for a first device to be used for one or more other devices without the user having to modify the software code, close an IDE in which the code was entered, and/or open a different IDE (e.g., a different instance of the IDE).

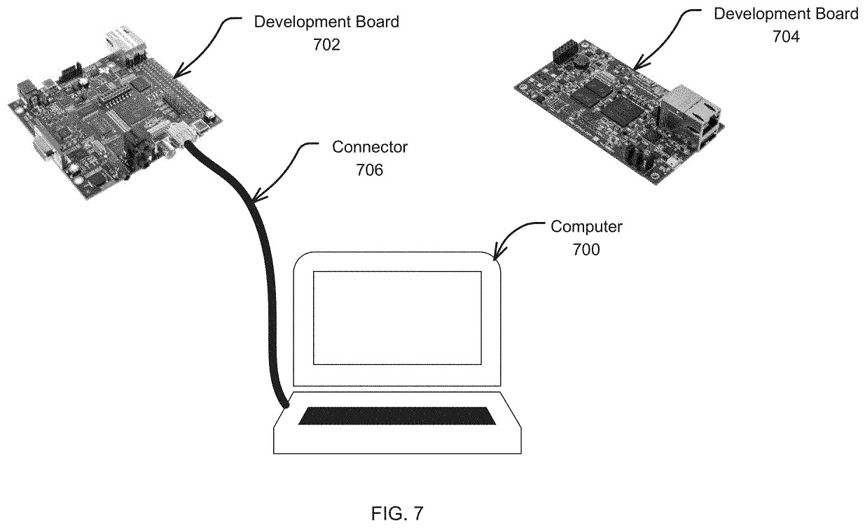

FIG. 7 illustrates an example of executing a set of software on multiple different devices, according to some embodiments of the technology described herein. As shown in FIG. 7, a computer 700 is connected to a first device (e.g., development board) 702 with a connector 706 (e.g., a USB connector). In some embodiments, IDE system 102 may be implemented on the computer 700. The computer 700 may be configured to execute a set of software code that operates the development board 702. For example, the set of software code may perform a test procedure for testing the first device 702. The first device 702 may be hot swapped for a second device (e.g., development board) 704 (e.g., as described in process 600). The computer 700 may be configured to execute the set of software code. The computer 700 may be configured to identify the second device 704 and load a device specific module of the second device (e.g., as described at blocks 608-610 of process 600). The computer 700 may be configured to use the second device module to automatically reconfigure the software code for the second device 704 (e.g., by replacing software coding constructs specific to the first development board 702 with those specific to the second development board 704 using the second device module). The computer 700 may then execute the software code to operate and/or communicate with the second device 704. For example, the computer 700 may be configured to repeat a test procedure performed on the first device 702 on the second device 704 by executing the software code. The software code may be executed without a user modifying the software code.

FIG. 8 shows a block diagram of an example computer system 800 that may be used to implement embodiments of the technology described herein. The computing device 800 may include one or more computer hardware processors 802 and non-transitory computer-readable storage media (e.g., memory 804 and one or more non-volatile storage devices 806). The processor(s) 802 may control writing data to and reading data from (1) the memory 804; and (2) the non-volatile storage device(s) 806. To perform any of the functionality described herein, the processor(s) 802 may execute one or more processor-executable instructions stored in one or more non-transitory computer-readable storage media (e.g., the memory 804), which may serve as non-transitory computer-readable storage media storing processor-executable instructions for execution by the processor(s) 802.

The terms “program” or “software” are used herein in a generic sense to refer to any type of computer code or set of processor-executable instructions that can be employed to program a computer or other processor (physical or virtual) to implement various aspects of embodiments as discussed above. Additionally, according to one aspect, one or more computer programs that when executed perform methods of the disclosure provided herein need not reside on a single computer or processor, but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform tasks or implement abstract data types. Typically, the functionality of the program modules may be combined or distributed.

Various inventive concepts may be embodied as one or more processes, of which examples have been provided. The acts performed as part of each process may be ordered in any suitable way. Thus, embodiments may be constructed in which acts are performed in an order different than illustrated, which may include performing some acts simultaneously, even though shown as sequential acts in illustrative embodiments.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

What is claimed is:

1. A method of software code development, the method comprising:
using a processor to perform:
determining a first identity of a first device connected to a computing device;
based on identification of the first identity of the first device, loading a first device module of a plurality of device modules, the first device module associated with the first identity, and the first device module comprising information indicating software coding constructs for the first device;
determining a code completion suggestion using the first device module associated with the first identity; and
providing the code completion suggestion to a user of the computing device.

2. The method of claim 1, wherein identifying the first identity of the first device comprises:
transmitting an instruction to the first device that, when executed by the first device, causes the first device to provide an indication of the first identity to the first computing device.

3. The method of claim 1, wherein the software coding constructs for the first device comprise classes, methods, and/or properties associated with a first device driver for operating the first device.

4. The method of claim 1, wherein:
determining the code completion suggestion comprises:
analyzing software code entered into the computing device; and
identifying at least one software coding construct to suggest to the user of the computing device based on the analyzing; and
providing the code completion suggestion to the user comprises providing an indication of the identified at least one software coding construct to the user.

5. The method of claim 1, wherein providing the code completion suggestion to the user of the computing device comprises displaying an indication of the code completion suggestion in a graphical user interface of an integrated development environment (IDE) shown in a display of the computing device.

6. The method of claim 1, further comprising executing software code, wherein execution of the software code causes the computing device to operate the first device.

7. The method of claim 6, further comprising:
identifying a second identity of a second device connected to the computing device; and
based on identification of the second identity of the second device, loading a second device module of the plurality of device modules, the second device module associated with the second identity, the second device module comprising information indicating software coding constructs for the second device.

8. The method of claim 7, further comprising:
after loading the second device module, executing the software code, wherein execution of the software code causes the computing device to operate the second device.

9. The method of claim 1, further comprising:
executing a debugging application; and
providing the code completion suggestion to the user of the computing device in a command line of the debugging application.

10. The method of claim 1, wherein the computing device comprises an evaluation board.

11. A system for software code development, the system comprising:
a processor,
a non-transitory computer-readable storage medium storing instructions that, when executed by the processor, causes the processor to perform a method comprising:
determining a first identity of a first device connected to the system;
based on identification of the first identity of the first device, loading a first device module of a plurality of device modules, the first device module associated with the first identity, and the first device module comprising information indicating software coding constructs for the first device;
determining a code completion suggestion using the first device module associated with the first identity; and
providing the code completion suggestion to a user of the computing device.

12. The system of claim 11, wherein identifying the first identity of the first device comprises:
transmitting an instruction to the first device that, when executed by the first device, causes the first device to provide an indication of the first identity to the first computing device.

13. The system of claim 11, wherein:
determining the code completion suggestion comprises:
analyzing software code entered into the system; and
identifying at least one software coding construct to suggest to the user of the system based on the analyzing; and
providing the code completion suggestion to the user comprises providing an indication of the identified at least one software coding construct to the user.

14. The system of claim 11, wherein the method further comprises executing software code, wherein execution of the software code causes the system to operate the first device.

15. The system of claim 14, wherein the method further comprises:
identifying a second identity of a second device connected to the system; and
based on identification of the second identity of the second device, loading a second device module of the plurality of device modules, the second device module associated with the second identity, the second device module comprising information indicating software coding constructs for the second device.

16. The system of claim 15, wherein the method further comprises:
after loading the second device module, executing the software code, wherein execution of the software code causes the system to operate the second device.

17. A non-transitory computer-readable storage medium storing instructions that, when executed by a processor, cause the processor to perform a method comprising:
determining a first identity of a first device connected to a computing device;
based on identification of the first identity of the first device, loading a first device module of a plurality of device modules, the first device module associated with the first identity, and the first device module comprising information indicating software coding constructs for the first device;
determining a code completion suggestion using the first device module associated with the first identity; and
providing the code completion suggestion to a user of the computing device.

18. The non-transitory computer-readable storage medium of claim 17, wherein identifying the first identity of the first device comprises:
transmitting an instruction to the first device that, when executed by the first device, causes the first device to provide an indication of the first identity to the first computing device.

19. The non-transitory computer-readable storage medium of claim 17, wherein:
determining the code completion suggestion comprises:
analyzing software code entered into the computing device; and
identifying at least one software coding construct to suggest to the user of the computing device based on the analyzing; and
providing the code completion suggestion to the user comprises providing an indication of the identified at least one software coding construct to the user.

20. The non-transitory computer-readable storage medium of claim 17, wherein providing the code completion suggestion to the user of the computing device comprises displaying an indication of the code completion suggestion in a graphical user interface of an integrated development environment (IDE) shown in a display of the computing device.
